(19) United States
(12) Patent Application Publication
(10) Pub. No.: US 2026/0239286 A1
(43) Pub. Date: Aug. 13, 2026

(54) POSITIONING SIGNALS METHOD USING RECONFIGURABLE INTELLIGENT SURFACES

(71) Applicant: QUALCOMM Incorporated, San Diego, CA (US)

(72) Inventors: Zhikun WU, Beijing (CN); Yu ZHANG, San Diego, CA (US); Peter GAAL, San Diego, CA (US); Wanshi CHEN, San Diego, CA (US); Alexandros MANOLAKOS, Athens (GR); Jing LEI, San Diego, CA (US); Hyojin LEE, San Diego, CA (US); Ahmed ELSHAFIE, San Diego, CA (US)

(21) Appl. No.: 19/471,736

(22) PCT Filed: May 12, 2023
(86) PCT No.: PCT/CN2023/093782

§ 371 Date: Oct. 2, 2025

(51) Int. Cl. H04W 64/00; H04B 7/04

(52) U.S. Cl. CPC H04W 64/00; H04B 7/04013

(57) ABSTRACT

A method for providing positioning signals with a re-configurable intelligent surface (RIS) includes selecting a movable assistant transceiver; receiving, at the RIS, a plurality of sequential positioning assistance signals (PASs) from the movable assistant transceiver; and directing the plurality of sequential PASs, via the RIS, at a plurality of direction angles, each corresponding to a respective one of the sequential PASs. Viewed from an alternative perspective, the method may include receiving, at a movable assistant transceiver, a request for assistance; and responsive to the request, transmitting, from the movable assistant transceiver to the RIS, a plurality of PASs for direction by the RIS. RIS-assisted positioning of a UE may be provided even in the absence of PRS signals from a gNB or other TRP that is separate from the RIS.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example method of providing positioning signals with a reconfigurable intelligent surface (RIS) according to the disclosure includes selecting a movable assistant transceiver, receiving, at the RIS, a plurality of sequential positioning assistance signals (PASs) from the movable assistant transceiver, and directing the plurality of sequential PASs, via the RIS, at a plurality of direction angles, each corresponding to a respective one of the plurality of sequential PASs.

An example method of providing positioning signals with a reconfigurable intelligent surface (RIS) according to the disclosure includes receiving, at a movable assistant transceiver, a request for assistance, and responsive to the request for assistance, transmitting, from the movable assistant transceiver to the RIS, a plurality of sequential positioning assistance signals (PASs) for direction via the RIS.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5A is a simplified diagram of a wireless communication environment including Reconfiguration Intelligent Surfaces (RISs).

FIG. 5B is a system diagram of an example RIS controller.

FIG. 6 is a schematic diagram illustrating a wireless communication environment in which base station signals are not available for RIS-assisted positioning of a UE.

FIG. 7 is a schematic diagram illustrating a wireless communication environment in which an embodiment method of RIS-assisted positioning may be performed without base station signals.

FIG. 8 illustrates a bar chart showing power levels (i.e., signal strengths) of various positioning assistance signals (PASs) detected by a user equipment (UE) in a positioning process.

FIG. 9 illustrates different example time and frequency characteristics of a plurality of sequential PAS signals that may be used in various embodiments.

FIG. 10A is a swim lane diagram illustrating an overall signal flow for an embodiment positioning assistance process in which a UE initializes a request for positioning assistance and an RIS relays the request to a potential assistant UE.

FIG. 10B is a swim lane diagram illustrating an overall signal flow for an embodiment positioning assistance process in which an RIS initializes the process.

FIG. 11 is a schematic diagram illustrating initialization of a positioning request directly from a UE to a candidate assistant UE according to an embodiment.

FIG. 12 is a schematic diagram illustrating use of satellite signals for RIS-assisted positioning according to an embodiment.

FIG. 13 is a flow diagram illustrating an embodiment method of providing positioning signals, performed at an RIS.

FIG. 14 is a flow diagram illustrating an embodiment method of providing positioning signals, performed at a movable assistant transceiver.

FIG. 15 is a flow diagram illustrating an embodiment method of positioning a UE, performed at an RIS.

FIG. 16 is a flow diagram illustrating an embodiment method of positioning a UE, performed at a movable assistant transceiver.

### DETAILED DESCRIPTION

Techniques are disclosed herein for positioning a UE with the assistance of an RIS, and without a need for positioning reference signals (PRS) such as those from a general Node B (gNB) or other transmission reception point (TRP) that is separated from the RIS. Configurations other than those specifically described and illustrated may be used.

Items and/or techniques described herein may provide one or more of the following capabilities, as well as other capabilities not mentioned. A capability to position a UE with the assistance of an RIS may be provided, even absent signals from a gNB or other TRP that is separated from the RIS. In one example, one or more other UE devices designated as “assistant UE(s)” can provide PAS transmissions that are directed by the RIS at different direction angles to be detected by the UE. The direction by the RIS may be implemented via transmission or reflection. In the case of transmission, the direction by the RIS at different direction angles may be via refraction or diffraction. Nonetheless, even absent assistant UE(s), the PAS transmissions may be provided by a satellite system and reflected or refracted at different angles to be detected by the UE. Sidelink PRS (SL-PRS) may also be utilized as PAS in embodiments. Heavy gNB-RIS signaling that typically accompanies RIS-and gNB-assisted positioning may be avoided. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

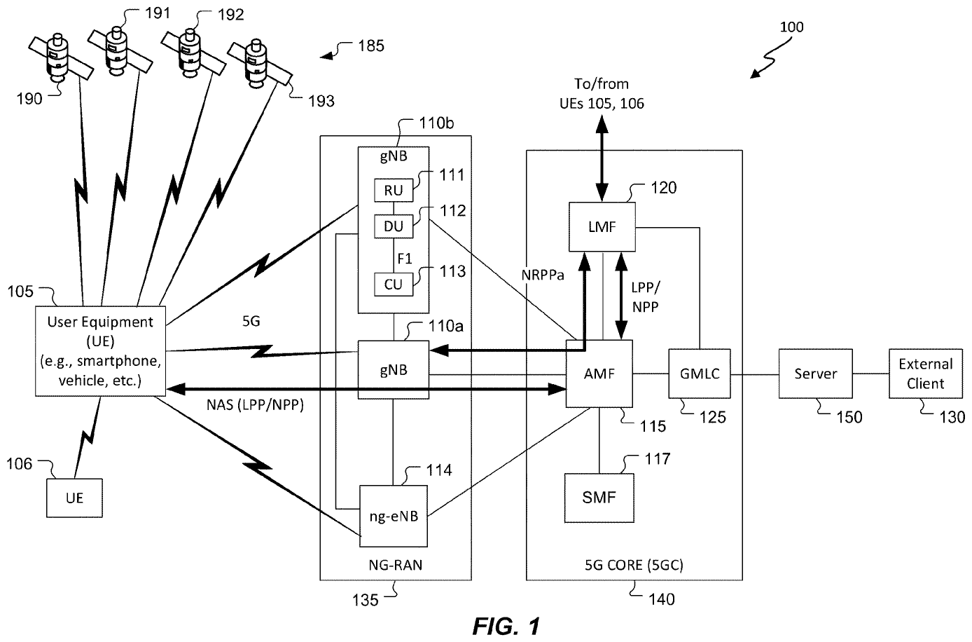

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or movable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

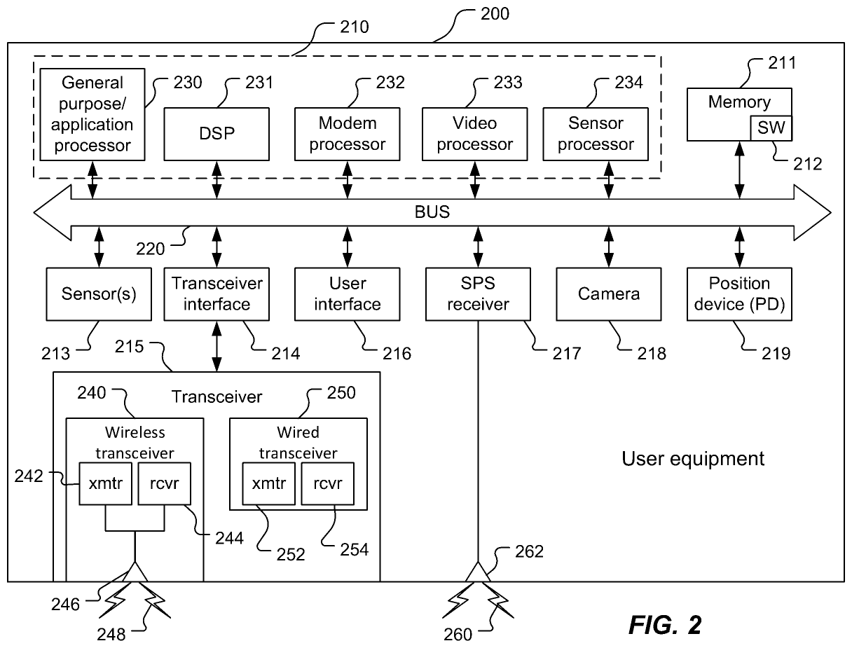

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

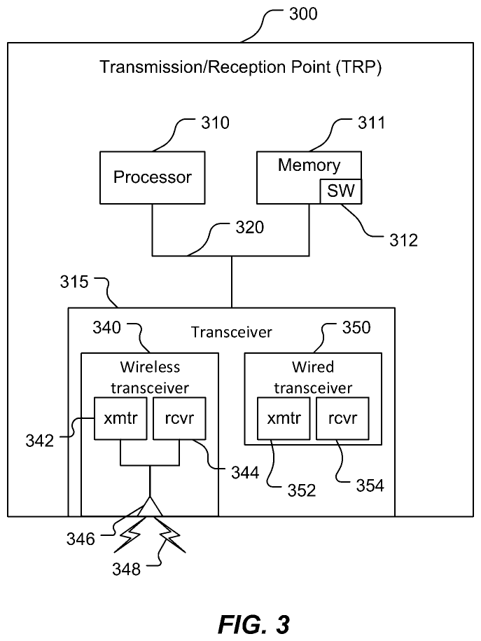

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

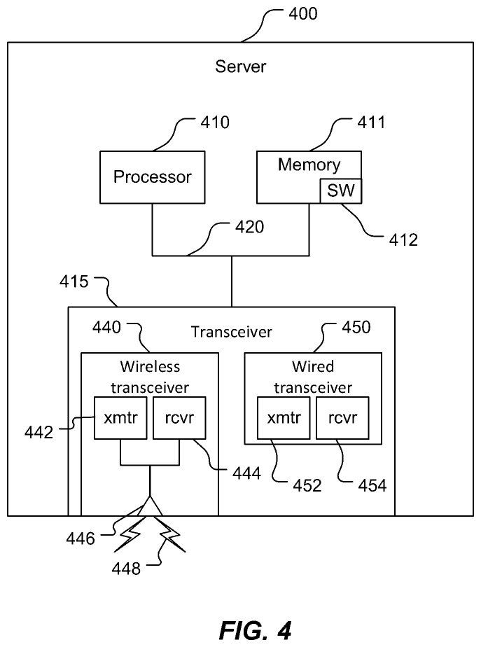

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V 2X (PC5), IEEE 802.11 (including IEEE 802.11p), WiFi®, WiFi® Direct (WiFi®-D), Bluetooth®, Zigbee® etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} Or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

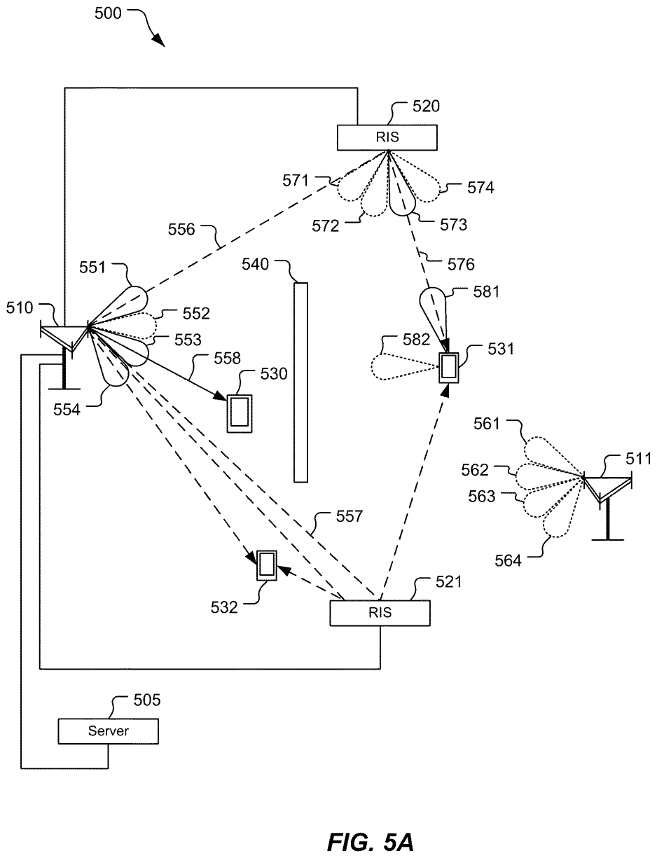

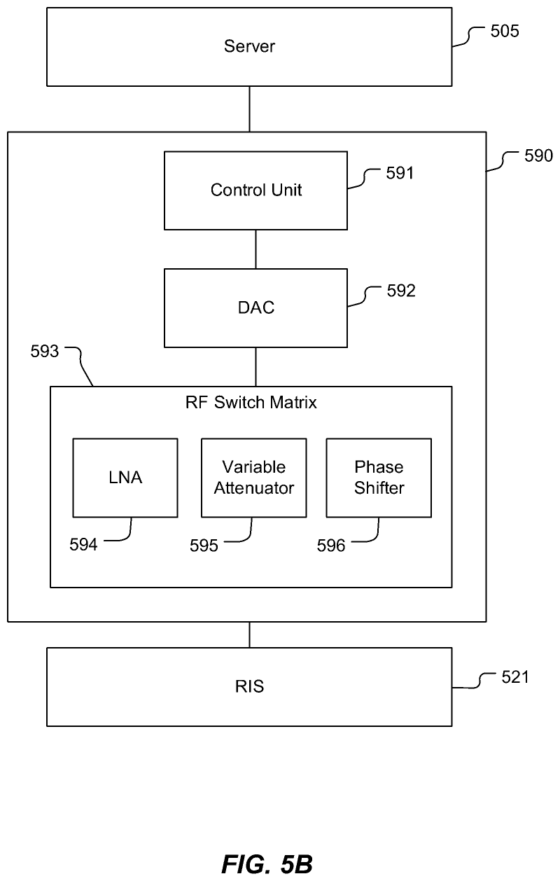

Referring to FIG. 5A, a wireless communication environment 500 includes a server 505, TRPs 510, 511, reconfigurable intelligent surfaces (RISs) 520, 521, UEs 530, 531, 532 and an obstacle 540 (e.g., a building or other object that inhibits/blocks RF signals). The server 505 may be an example of the server 400, the TRPs 510, 511 may be examples of the TRP 300, and the UEs 530, 531 may be examples of the UE 200 or examples of other UEs discussed herein. The TRPs 510, 511 are configured to communicate (transmit and/or receive wireless signals) with at least antenna beams 551, 552, 553, 554, 558, 561, 562, 563, 564, respectively. The RISs 520, 521 are artificial structures with engineered electromagnetic (EM) properties. The RISs 520, 521 are configured to receive wireless signals from a transmitter (e.g., a base station or UE) and passively beamform and retransmit (e.g., without power amplification) the received signals via one or more beams, with the retransmitted signals referred to as reflected signals, toward a receiver (e.g., a base station or UE). An RIS can be configured to reflect an impinging signal to a desired direction. For example, each of the RISs 520, 521 may be dynamically configured to transmit the respective reflected signals toward one or more receivers such as one or more of the UEs 530-532. The RIS 520 is configured, in this example, to use antenna beams 571, 572, 573, 574 to transmit and/or receive wireless signals.

In the example illustrated in FIG. 5A, the TRP 510 is connected to, and configured to control, the RISs 520, 521 to control the direction(s) of the reflected signals from the RISs 520, 521. As shown, the TRP 510 is unable to communicate directly with the UE 531 due to the obstacle 540 being disposed along the line of sight (LOS) direction between the TRP 510 and the UE 531 (e.g., the beam 552 from the TRP 510 to the UE 531). The UE 531 is disposed behind the obstacle 540 relative to the TRP 510 and thus unable to receive an LOS beam (the beam 552) from the TRP 510. The TRP 510 may be aware that the obstacle 540 creates a coverage hole, i.e., a geographic area in which signals from the TRP 510 cannot directly reach or may reach but be attenuated enough to make detection of the signal difficult or impossible by a UE within the coverage hole. In this scenario, the TRP 510 may bounce a signal off of one or more RISs into the coverage hole to provide coverage to devices in the coverage hole, including devices about which the TRP 510 is not currently aware. For example, the TRP 510 may use the beam 551 to transmit a signal 556 to the RIS 520, and control the RIS 520 to reflect the incoming signal into the beam 573 to transmit a reflected signal 576 toward the UE 531, thereby communicating with the UE 531 around the obstacle 540. The TRP 510 may configure the RIS 520 to reflect UL signals from the UE 531 into the beam 571 to the TRP 510. In another example illustrated in FIG. 5A, the TRP 510 may transmit a signal 557 to the RIS 521, and control the RIS 521 to reflect the incoming signal 557 toward the UE 531, thereby communicating with the UE 531 around the obstacle 540.

The environment may be used to help with signal exchange between one or more TRPs and one or more low-tier (e.g., low-power, low-bandwidth, low-antenna-count, low baseband processing capability) UEs, such as an “NR light” UE or a reduced-capability UE (i.e., an “NR RedCap” UE), which may not have the capability to hear or detect a PRS transmitted from a non-serving TRP, especially from a TRP that is far from the UE. Likewise, an SRS measurement by a non-serving TRP of an SRS from a low-tier UE may be of lower quality than an SRS measurement from a UE that is not a low-tier UE. The use of one or more of the RISs 520, 521 may enable the exchange of one or more additional signals between the TRP 510 and the UE 531. The use of the RISs 520, 521 from a single TRP, here the TRP 510, may reduce or eliminate synchronization errors that may occur with multiple signals from multiple TRPs, which may help improve, for example, positioning accuracy based on signal exchange between the TRP 510 and the UE 531.

One or more of the UEs 530-532 may be within a coverage area of a TRP, e.g., the TRP 510, only without RIS signal reflection (e.g., the UE 530), only with RIS signal reflection (e.g., the UE 531), with or without RIS signal reflection (e.g., the UE 532), or not within the coverage area of the TRP (although not shown in FIG. 5A). Due to mobility of the UEs 530-532, any of the UEs 530-532 may be in one coverage situation (e.g., only without RIS reflection) at one time and another coverage situation (e.g., only with RIS reflection) at another time. Also, a UE may not be able to receive and measure signals from both the TRP 510 directly and from the RIS 520 at the same time/location due to the beam directions of the signals from the TRP 510 and the RIS 520, respectively. For example, the UE 531 may attempt to measure a synchronization signal (e.g., an SSB (Synchronization Signal Block)) transmitted by the TRP 510 in each of the beams 551-554 and be unable to measure the synchronization signal from any of the beams 551-554, but be able to measure the synchronization signal sent in the beam 551 and reflected in the beam 573 from the RIS 520 using a beam 581 of the UE 531. The UE 531 may not be able to measure a signal in the beam 573 adequately using a beam 582 directed in an LOS direction toward the TRP 510.

Referring to FIG. 5B, a system diagram of an example RIS controller 590 is shown. The controller 590 is an example of a control circuit configured to control the reflection coefficients in the RIS 520, 521. In an example, the controller 590 may be communicatively coupled to the server 505 and one of the RIS 520, 521 (e.g., the RIS 521). The controller 590 may be included within the server 505, the RIS 521, the TRP 510, or other entities in the communication environment 500 for configuring the reflections from the RIS 520, 521. A control unit 591 may include one or more microcontrollers and may be configured to receive control signals from the server 505. In an example, the control signals may be conveyed via a Xn interface from the server 505 via a gNB or other network entity. Other control plane protocols may also be used. The control unit 591 may utilize a digital-to-analog converter (DAC) 592 to generate an analog voltage signal representing the desired phase and amplitude of a signal to be reflected by the RIS 521. In an example, the control unit 591 may include one or more code books (e.g., look-up-tables or other data structures) to correlate the phase and amplitude information with desired reflection performance. A RF switch matrix 593 may be configured to receive the analog voltage signal and control the phase and amplitude of the signal reflected by elements in the RIS 521. In an example, the RF switch matrix 593 may include low-noise amplifiers (LNAs) 594, variable attenuators 595, and phase shifters 596 operably coupled to the elements of the RIS 521. The control unit 591 may be configured to monitor the performance of the RIS 521 and adjust the reflection coefficients of each element to realize the desired reflected beam quality. In an example, machine learning algorithms may be used to improve the code books to adapt the configuration of the RF switch matrix 593 based on network conditions and the desired coverage area.

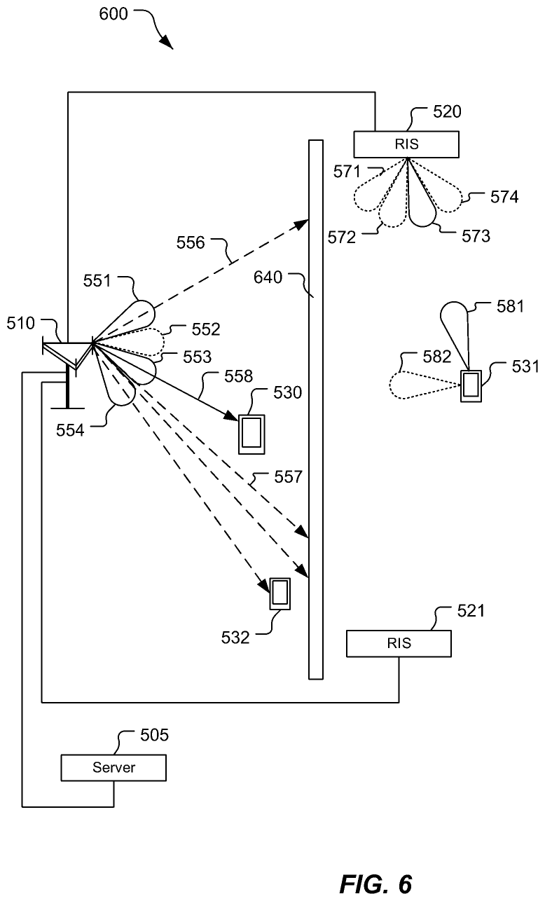

Referring to FIG. 6, an example wireless communication environment 600 illustrates a problem that may be solved by embodiments disclosed herein. The wireless communication environment includes the elements of the environment 500 of FIG. 5A, except that the TRP 511 is not present. Furthermore, the environment 600 includes an obstacle 640 (e.g., a building or other object that inhibits/blocks RF signals) that is longer than the corresponding, similarly placed obstacle 540 of FIG. 5A. The obstacle 640 prevents the signal 556 from reaching the RIS 520 to be reflected to the UE 531. The obstacle 640 also prevents the signal 557 from reaching the RIS 521 for communication with the UE 531. Given the geometry of the obstacle 640 and the absence of the TRP 511 from the communication vicinity of the UE 531, the UE 531 does not have good access to a TRP for positioning purposes.

Due to the example situation illustrated in FIG. 6 and other possible reasons, in some cases there is no TRP or gNB available to assist with RIS-based positioning in the manner described in FIG. 5A. Disclosed herein are methods and apparatuses for providing positioning signals using an RIS without a TRP. Specifically, methods and corresponding apparatuses disclosed herein for providing positioning signals may allow an RIS to assist a UE with positioning, with the benefit of one or more assistant UEs that may work together with the UE and the RIS. This approach solves a problem of a TRP not being available. Furthermore, the disclosed methods and apparatuses can avoid heavy gNB-RIS signaling (since the RIS controller can connect to the network) and allow the UE to control the RIS for positioning.

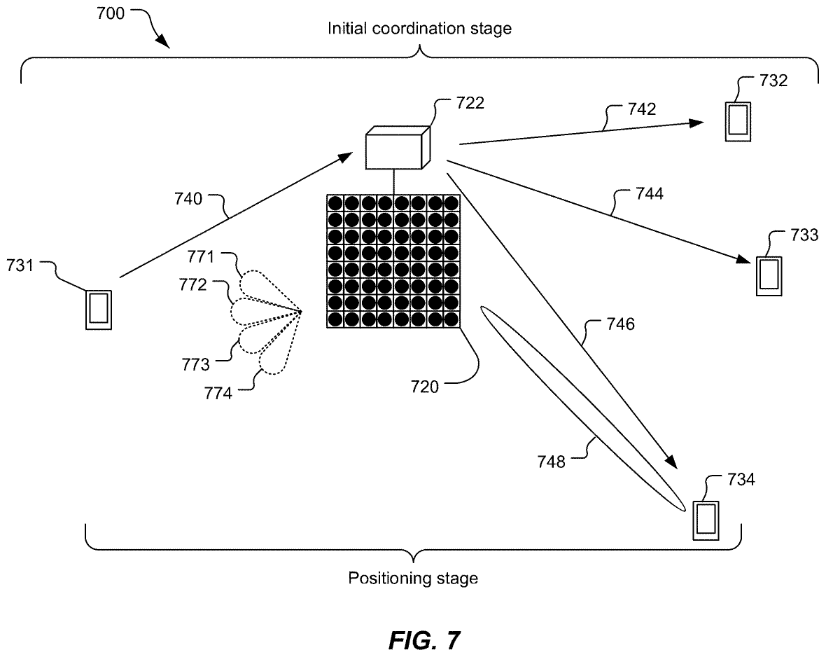

FIG. 7 is a schematic diagram illustrating a wireless communication environment 700. In the wireless communication environment 700, an RIS 720 is separate from a gNB or another TRP, such as described in FIG. 6. An RIS controller 722 may include some or all of the components of the controller 590 and may be operably coupled to the RIS 720 and another network entity (e.g., a gNB, TRP, LMF, etc). The RIS controller 722 may include some or all of the components of a TRP 300 and/or a server 400, and may be configured to communicate directly with other wireless devices (e.g., UEs) in a coverage area. In an example, the RIS 720 and the RIS controller 722 may be stand alone units configured to operate independent of a communication network. In an example use case, a UE 731 may require positioning assistance. During an initial coordination stage that is shown in FIG. 7, the UE 731 may be configured to communicate with the RIS 720 (e.g., the RIS controller) by sending a request for positioning 740. The request for positioning 740 may utilize over-the-air (OTA) techniques such as NAS messaging, Radio Resource Control (RRC) and/or other OTA techniques. The RIS controller 722 may be configured to relay this positioning request via signals 742, 744, 746 to various candidate assistant UEs 732, 733, 734, respectively, which are in communication range of the RIS 720 and may potentially be available to assist with positioning. A candidate assistant UE 734, chosen by way of example, may indicate that it is available for positioning assistance, and the RIS 720 then requests positioning signals with particular time and frequency configurations. The RIS controller 722 may be configured to select one of multiple responding candidate assistant UEs based on one or more factors such as the location of a UE, the signal strength of a UE, and other factors described herein.

Subsequently, during a positioning stage that is illustrated, the assistant UE 734 may be configured to repeatedly transmits PASs 748 to the RIS 720. The RIS 720 uses different RIS configurations to reflect the sequential PAS 748 to different angles, as illustrated by the reflected PAS 771, 772, 773, 774. In an example, the RIS controller 722 may be configured to transmit assistance data including the boresight angles of the reflected PAS 771, 772, 773, 774 to the UE 731. The assistance data may be transmitted via NAS messaging, RRC and/or via other OTA broadcast and/or unicast techniques. The UE 731 may be configured to detect one or more of the reflected, sequential PASs 771, 772, 773, 774 and measure the respective signal strengths to determine an angular position of the UE 731 with respect to the RIS 720. With the determined angular position, the UE position may be established based on known positioning methods, such as AoA, AoD, TDoA, ToA, RSSI, etc.

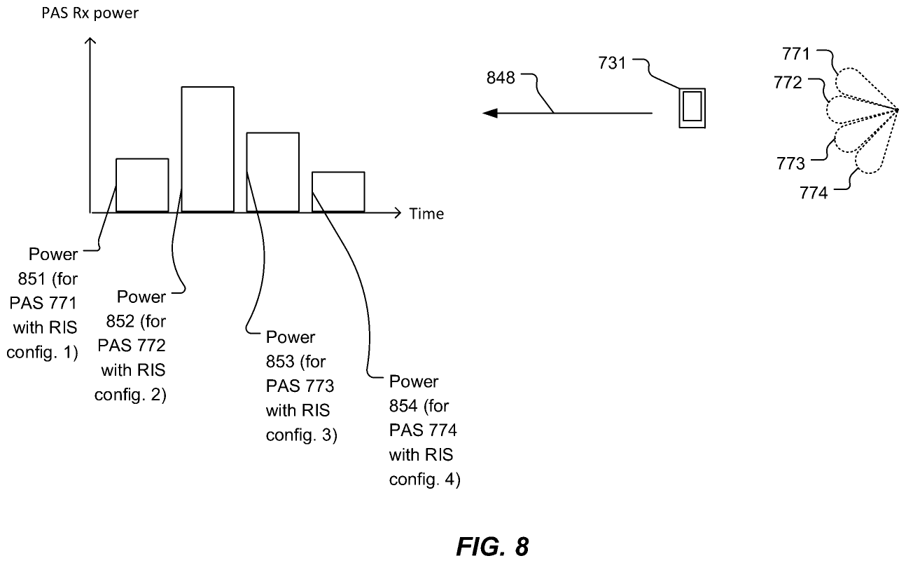

Referring to FIG. 8, with further reference to FIG. 7, a bar chart showing power levels (i.e., signal strengths) 851, 852, 853, 854 of reflected PAS is illustrated. The power levels are for respective reflected PAS detected by the UE 731. As illustrated at the right of FIG. 8, the UE 731 receives the sequential, reflected PAS 771, 772, 773, 774. The UE 731 measures powers 851, 852, 853, 854 corresponding, respectively, to the sequential PAS 771, 772, 773, 774. This measurement is indicated by an arrow 848, and the results are shown in the bar chart. Since the power 852 is greatest, the UE 731 may conclude that the corresponding PAS 772 is directed at the best angle to reach the UE 731. With the assistant UE 734 position being known, and with the position and angular configuration of the RIS 720 known, the UE 731 or the RIS controller 722 (or other network entity) may be configured to determine an estimate for the location of the UE 731 based at least in part on the angle of the reflected PAS 772.

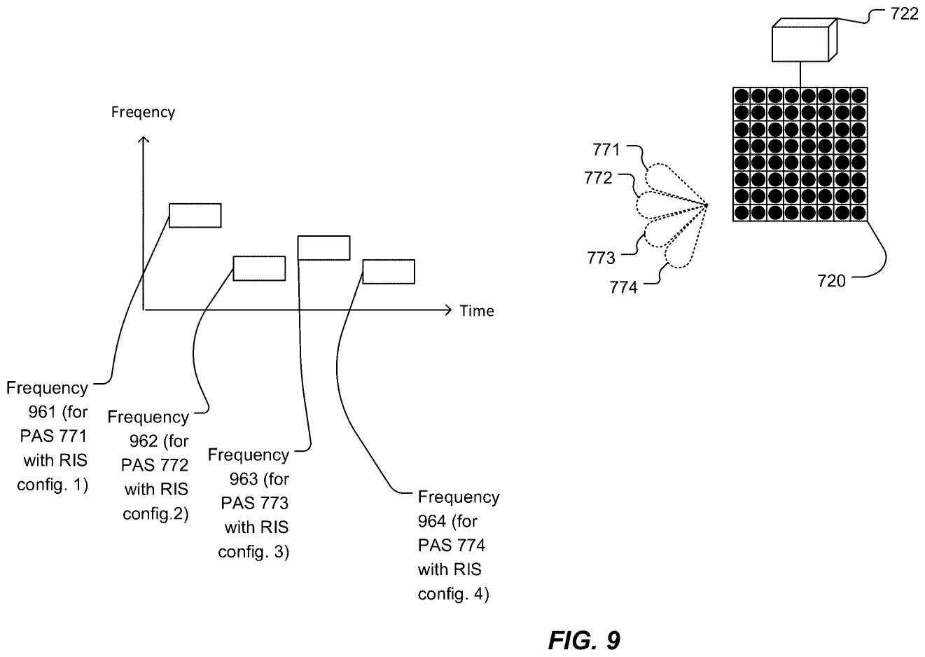

Referring to FIG. 9, with further reference to FIG. 7 and FIG. 8, a chart is provided showing an example time and frequency configuration for each of the respective, sequential PAS 771, 772, 773, 774. Specifically, a first RIS configuration (including reflection angle) is used for the PAS signal 771, which is at a PAS frequency 961. Similarly, second, third, and fourth RIS configurations (with respective reflection angles over the angular sweep) are used for the respective PAS 772, 773, 774, which have corresponding respective PAS frequencies 962, 963, 964 used by the assistant UE 734 illustrated in FIG. 7. This illustrates a general feature of embodiments, which is that each PAS of a plurality of sequential PAS may have a different frequency and correspond to a different RIS configuration. The frequencies 961, 962, 963, 964 may be included in assistance data transmitted by the RIS controller 722. In an example, the frequencies 961, 962, 963, 964 may be within a bandwidth part (BWP) configured on the UE 731.

Preferably, the sequential PAS may be transmitted in a periodic manner. However, most generally, the PAS are merely sequential and need not be strictly periodic. Generally, it is preferable for the RIS (specifically, the RIS controller 722) to sense and broadcast, groupcast, or unicast time and frequency configurations for the PAS signals to other devices in the communication environment 700. Nonetheless, in other embodiments, the UE 731 may be configured to sense and broadcast the time and frequency configurations for the PAS signals to the other devices. In an example, a network resource such as the LMF 120 may be configured to preconfigure PAS resources to those network devices, thus the UE 731 and the assistant UE 734 may have the PAS resource configurations available in local memory.

In a particular example embodiment, the PAS are side link PRS (SL-PRS) signals originating from a different assistant UE and relayed by the assistant UE 734 to the RIS 720. In this case, the assistant UE 734 may optionally sense time and frequency characteristics of the PAS signals and broadcast, groupcast, or unicast these characteristics to other device in the communication environment 700. In other embodiments, the PAS signals can be GNSS signals.

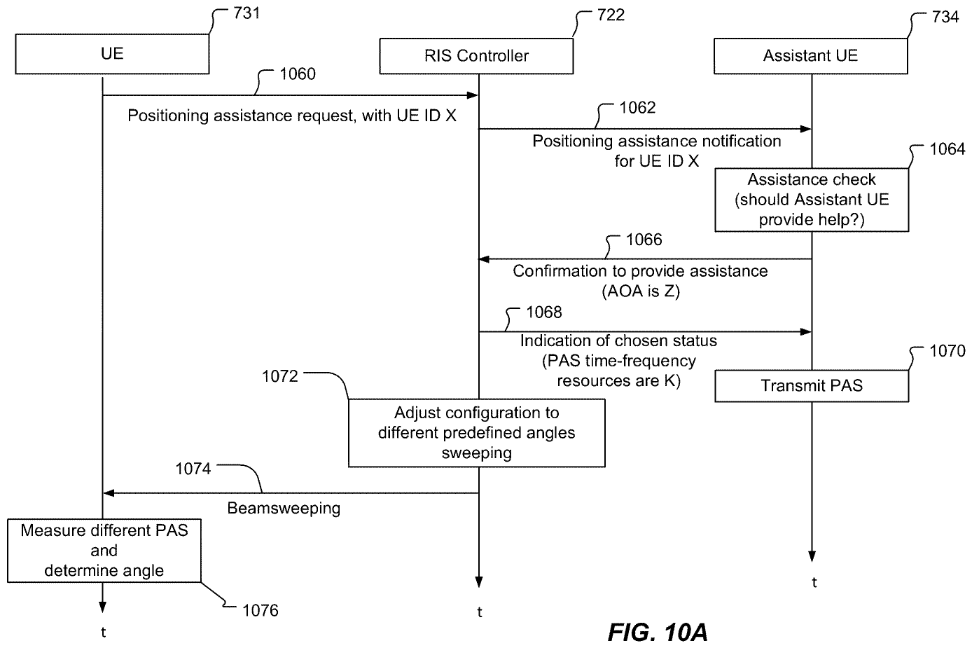

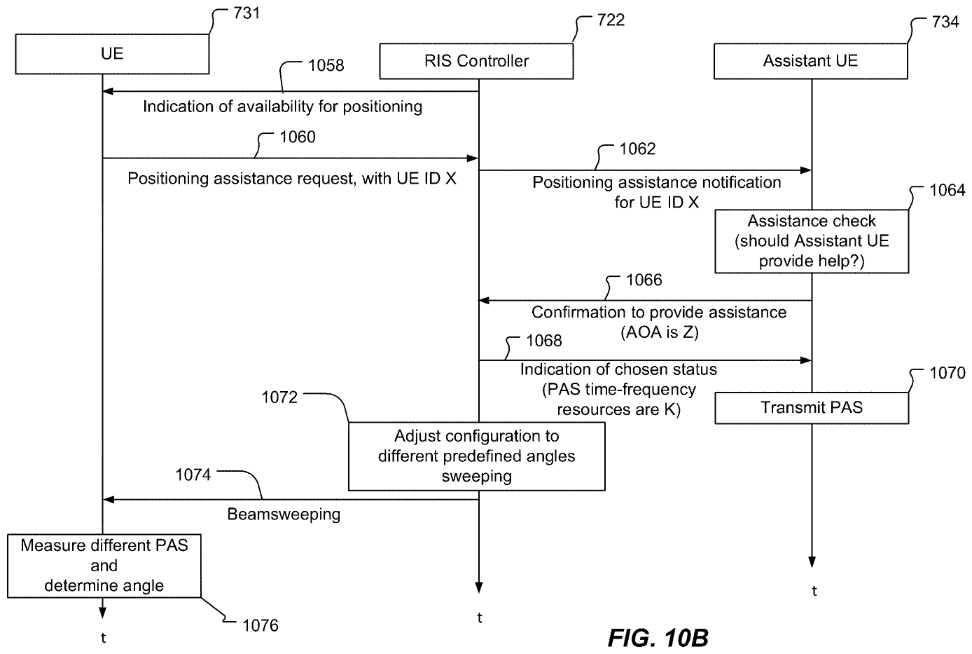

Referring to FIG. 10A, with further reference to FIGS. 6-9, a swim lane diagram is providing, illustrating an overall signaling flow for an example process of providing positioning signals with the UE 731. The signal flow is between the UE 731, the RIS 720, and the assistant UE 734, by way of example. In the example of FIG. 10A, the UE 731 initializes the process by sending a positioning assistance request 1060, which includes an identification (ID) X for the UE 731. In an example, the positioning assistance request 1060 may utilize NAS protocols, RRC or other OTA messaging. In a vehicle-to-everything (V2X) use case, a roadside unit (RSU) may be configured as an RIS controller and the UE 731 may be configured to utilize sidelink such as the PC5 protocol to communicate with the RSU. An RIS controller may be configured to utilize the Uu interface. The UE 734 may utilize other device-to-device (D2D) techniques to detect the presence of the RIS 720 before transmitting the positioning assistance request 1060. Following the request for positioning assistance 1060, the RIS controller 722 may be configured to send a positioning assistance notification 1062 to one or more candidate UEs such as the assistant UE 734 (e.g., the candidate UEs may be neighboring UEs within communication ranges such as the UEs 732, 733, 734). The positioning assistance notification 1062 may be broadcast, groupcast, and/or unicast using known OTA messaging techniques. The positioning assistance notification 1062 may include identification information for the requesting UE (e.g., an ID X for the UE 731). At this stage, the assistant UE 734 can be considered a “potential” assistant UE until the assistant UE 734 determines that it can accept the positioning assistance request and until the RIS controller 722 indicates that the UE 734 is chosen to provide the positioning assistance.

At stage 1064, the potential assistant UE 734 may be configured to perform an assistance check to determine whether it should provide positioning assistance. In an example, the RIS controller 722 may be configured to perform the assistance check at stage 1064. The assistance check may be based on one or more different factors which may impact the quality of the received and/or reflected RF signals. For example, the location of the candidate UE (e.g., the distance between RIS 720 and the assistant UE 734) may be a factor. In an example, the RSSP, RSSI, and/or RSRQ values may be compared to threshold values to determine if the assistant UE 734 should be selected. In general, a UE will not be selected as an assistant UE if it is located too far away from the RIS. Other geometrical factors, such as the AOA/AOD between assistant UE 734 and the RIS 720 may be used. For example, a UE that is located behind an RIS will not be selected. The mobility state of UE may be utilized as a factor for selecting an assistant UE. For example, a UE that is moving or that is moving above a threshold velocity may not be selected. The power status of a UE may be utilize as a factor (e.g., a UE with low battery power may not be selected). The discontinuous reception (DRX) pattern of a UE may be used a factor (e.g., a UE that is going to sleep, or currently sleeping, may not be selected).

If the potential assistant UE 734 determines that it can provide assistance at stage 1064, then it may be configured to send a confirmation to provide assistance 1066. The RIS controller 722 may be configured to select a UE from the candidate UEs based on one or more of the factors previously described, and then to send an indication of chosen status 1068. In an example, the indication of chosen status 1068 may include time and frequency resources that the assistant UE 734 may utilize during the positioning beam sweep.

At a stage 1070, the assistant UE 734 may be configured to transmit PAS to the RIS 720. The PAS may be, for example, the PAS 771-774 illustrated in FIGS. 8-9. At a stage 1072, the RIS controller 722 may adjust the configuration of the RIS 720 to reflect the PAS signals at different angles. These configuration adjustments allow the RIS 720 to deflect the PAS transmitted from the assistant UE 734 at different angles to achieve an angular beam sweeping 1074, as described in FIGS. 5-9. At a stage 1076, the UE 731 may measures strength of the various reflected PAS received during the beam sweeping 1074. The UE 731 optionally utilize assistance data to determine an angle of departure (AoD) associated with the received PAS with the strongest signal, as illustrated in the example FIG. 8.

FIG. 10B is a swim lane diagram that illustrates overall signaling exchange between the UE 731, the RS controller 722, and the assistant UE 734. In contrast to the FIG. 10A example, the RIS controller 722 in FIG. 10B is configured to initialize the process of providing positioning signals. In an example, the RIS controller 722 may be configured to send an indication of availability for positioning 1058 to the UE 731. The indication of availability for positioning 1058 may be broadcast, groupcast, or unicast to UEs in an associated coverage area. After the indication of availability for positioning 1058, the signaling flow is the same as that of the FIG. 10A example.

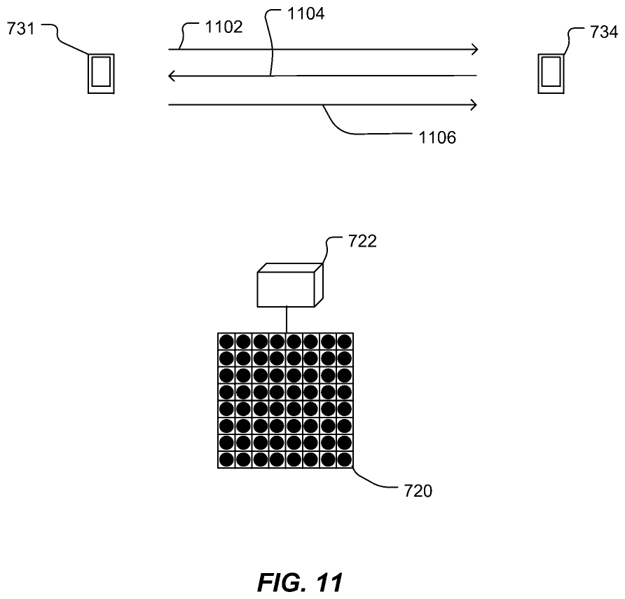

Referring to FIG. 11, with further reference to FIGS. 7-10B, a schematic diagram illustrates an embodiment wherein the UE 731 initializes a positioning procedure with the RIS 720 by transmitting a positioning request 1102 directly to candidate assistant UEs, such as the example assistant UE 734. As part of the positioning request 1102, the UE 731 may provide an identification ID of any RIS that is nearby, such as the RIS 720. Following the positioning request 1102, a candidate assistant UE that is available for positioning, such as the assistant UE 734, may be configured to provide an indication of availability 1104 to the UE 731. The UE 731 may then decide which candidate assistant UE should be chosen to provide help, and the UE 731 may transmit a final positioning request 1106 to the chosen assistant UE. The UE 731 may be configured to utilize one or more of the factors previously described to select an assistant UE. For example, the UE 731 may utilize the locations of the candidate UE and the RIS as factors. The mobility state and/or power status of a candidate UE may be utilized as factors. Other factors which may impact the ability of a candidate UE to provide PAS may also be used.

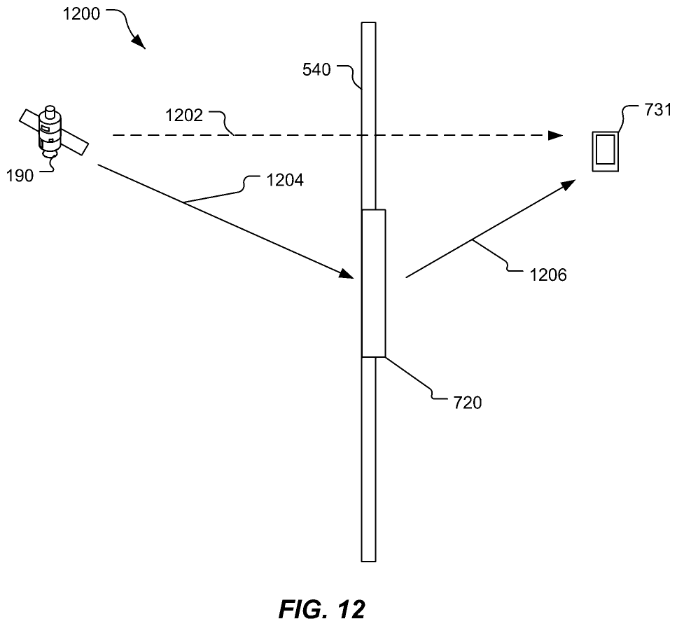

Referring to FIG. 12, with further reference to FIGS. 7-9, a wireless communication environment 1200 is illustrated schematically. The wireless communication environment 1200 exemplifies how the UE 731 and the RIS 720 may work in connection with the example satellite vehicle (SV) 190 (e.g., a GNSS system) to obtain positioning assistance. This can be done in the absence of any assistant UE. In an example, an obstacle 540 may block or otherwise attenuate a signal 1202 transmitted from the SV 190. In this example, the RIS 720 (i.e., the RIS controller 722, not shown in FIG. 12) may receive a positioning request from the UE 731. The RIS 720 may be in a position to receive signals 1204 from the SV 190 (e.g., GNSS signals) and may reflect or refract signals 1206 over a variety of angles to provide an angular sweep of PAS for positioning the UE 731. With this method, there is no need of an RIS-assistant UE signaling exchange. In an example, the GNSS receiver in the UE 731 may be configured to utilize the two-hop signal to determine the ToA of the refracted signal 1206 and compare it to the ToA of the signal 1204 received at the RIS 720.

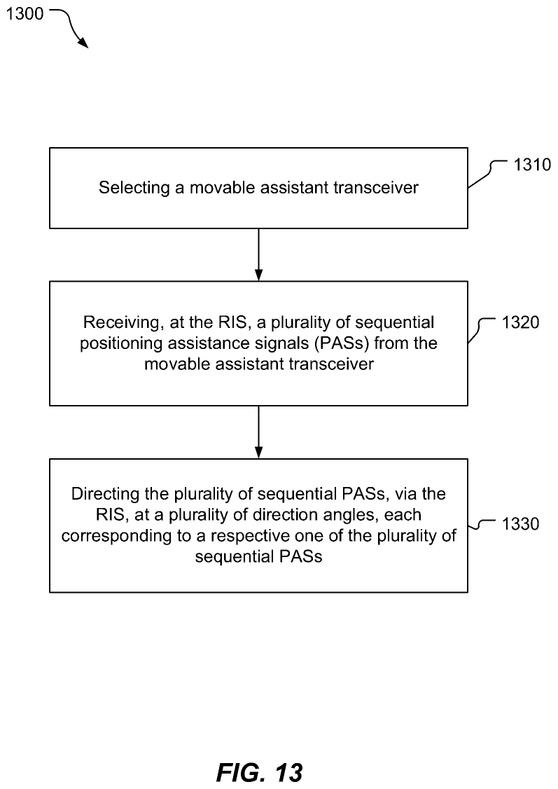

Referring to FIG. 13, with further reference to FIGS. 1-12, a method 1300 for providing positioning signals with a reconfigurable intelligent surface (RIS) is illustrated by a flow diagram and includes the stages shown. The method 1300 is, however, an example and not limiting. The method 1300 may be altered, e.g., by having stages added, removed, rearranged, combined, performed concurrently, and/or having single stages split into multiple stages.

At stage 1310, the method includes selecting a movable assistant transceiver. An RIS controller 722, including a processor 410 and a transceiver 415, is a means for selecting the movable assistant transceiver. In an example, a UE 200, including processors 210 and a transceiver 215, is a means for selecting the movable assistant transceiver. Example means for selecting the movable assistant transceiver include the RIS 720 and accompanying controller 722 of FIG. 7, or any of the other RISs described in the application. In an example, selecting the movable assistant transceiver may be based on performing an assistance check at stage 1064 discussed in FIG. 10A. The assistance check may performed by the movable assistant transceiver prior to providing a confirmation to provide assistance message 1066. The RIS controller 722 may be configured to select the movable assistant transceiver based on one or more different factors which may impact the quality of the received and/or directed RF signals. For example, the location of the movable assistant transceiver may be a factor. In an example, the RSSP, RSSI, and/or RSRQ values for signal transmitted by a movable assistant transceiver may be compared to threshold values to determine if it should be selected. In general, a movable assistant transceiver will not be selected if it is located too far away from the RIS. The selection of the movable assistant transceiver may be based other geometrical factors, such as the AOA/AOD between movable assistant transceiver and the RIS. For example, a movable assistant transceiver that is located behind an RIS will not be selected. The selection may be based on the mobility state of movable assistant transceiver. For example, a movable assistant transceiver that is moving or that is moving above a threshold velocity may not be selected. The selection may be based on power status and/or DRX pattern of a movable assistant transceiver. In an example, the movable assistant transceiver can be the assistant UE 734, or another transceiver such as SV 190 described in FIG. 12. In an example, a requesting UE, such as the UE 731 in FIG. 11 may be configured to select a movable assistant transceiver.

At stage 1320, the method includes receiving, at the RIS, a plurality of sequential positioning assistance signals (PASs) from the movable assistant transceiver. An RIS 720 and RIS controller 722 including a controller 590, are a means for receiving the plurality of sequential PASs. In an example, the movable assistant transceiver may be the assistant UE 734 configured to transmit PASs 748 to the RIS 720 repeatedly. The PAS may be configured as reference signals such as PRS, SRS, CSI-RS, SL-PRS or other reference signals which may be used in positioning or channel estimation procedures. In an example, the PAS may be configured as SL-PRS. The RIS 720 and the RIS controller 722 are configured to receive the sequential PASs. Other RIS configurations, such as a multi-panel RIS, or a sub-panel of an RIS may be configured to receive the PAS.

At stage 1330, the method includes directing the plurality of sequential PASs, via the RIS, at a plurality of direction angles, each corresponding to a respective one of the plurality of sequential PASs. The RIS 720 and RIS controller 722, including the controller 590, are a means for directing the plurality of sequential PAS (e.g. by reflection). In an example, the RIS controller 722 may include one or more code books (e.g., look-up-tables or other data structures) to correlate phase and amplitude information of the PAS with a desired reflection angle. The RIS controller 722 may include a RF switch matrix configured to and control the elements of the RIS 720 to enable the reflected PAS 771, 772, 772, 774 as described in FIG. 7. Other control circuits may be utilized to reflect the plurality of sequential PAS at the plurality of direction angles (e.g., reflection angles).

The method 1300 may further include providing a request for assistance to one or more candidate movable assistant transceivers, receiving indications to provide assistance from the one or more candidate movable assistant transceivers, and selecting the movable assistant transceiver based at least in part on the received indications to provide assistance. Example means for any one or more of the providing, the receiving, and the selecting include RIS 720, any of the RISs illustrated in FIGS. 5-6, a multi-panel RIS, or a sub-panel of an RIS or a controller thereof, such as the controller 722.

The method 1300 may further include determining location information for each of the one or more candidate movable assistant transceivers, and wherein selecting the movable assistant transceiver is based at least in part on the location information. Example means for the determining may include a controller that is configured to operate or control the selecting include RIS 720, any of the RISs illustrated in FIGS. 5-6, a multi-panel RIS, or a sub-panel of an RIS or a controller thereof, such as the controller 722. The location information for each of the one or more candidate movable assistant transceivers can be received from a network server, for example, such as the server 505 of FIGS. 5-6.

The method 1300 may further include determining state information for each of the one or more candidate movable assistant transceivers, and wherein selecting the movable assistant transceiver is based at least in part on the state information. Example means for determining the state information may include a controller that is configured to operate or control the selecting include RIS 720, any of the RISs illustrated in FIGS. 5-6, a multi-panel RIS, or a sub-panel of an RIS or a controller thereof, such as the controller 722. The state information may include a mobility state, a power state, a discontinuous reception pattern, or combinations thereof.

The method 1300 may further include receiving a request for positioning from a user equipment. Example means for receiving the request may include the RIS 720, any of the RISs illustrated in FIGS. 5-6, a multi-panel RIS, or a sub-panel of an RIS or a controller thereof, such as the controller 722. The state information may include a mobility state, a power state, a discontinuous reception pattern, or combinations thereof.

The method 1300 may further include transmitting an indication that the RIS is available for positioning. Example means for transmitting the indication include a controller that is configured to control the RIS 720, such as the controller 722.

The method 1300 may further include providing PAS timing and frequency information to the movable assistant transceiver. Example means for providing this information can include the RIS 720, any of the RISs illustrated in FIGS. 5-6, a multi-panel RIS, or a sub-panel of an RIS or a controller thereof, such as the controller 722.

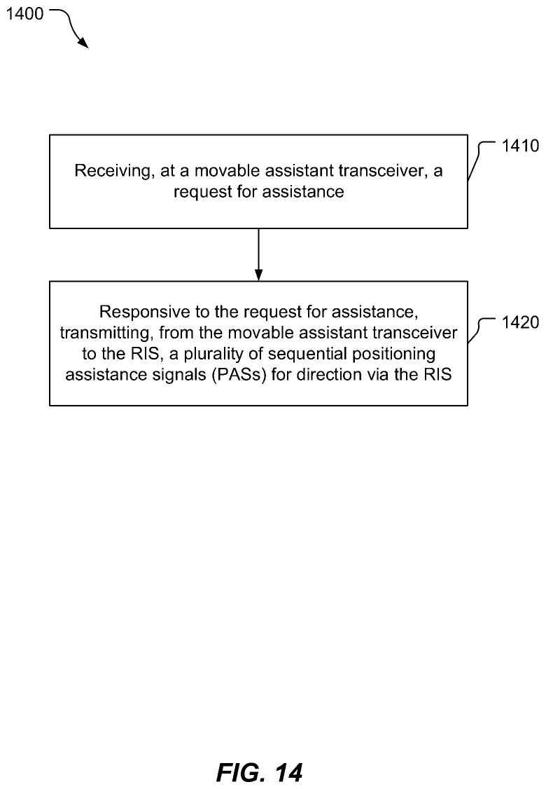

Referring to FIG. 14, with further reference to FIGS. 1-13, a method 1400 of providing positioning signals with a reconfigurable intelligent surface (RIS) is illustrated in a flow diagram and includes the stages shown. The method 1400 is, however, an example and not limiting. The method 1400 may be altered, e.g., by having stages added, removed, rearranged, combined, performed concurrently, and/or having single stages split into multiple stages.

At stage 1410, the method includes receiving, at a movable assistant transceiver, a request for assistance. A UE 200, including processors 210 and a transceiver 215, is a means for receiving a request for assistance. The movable assistant transceiver may be the assistant UE 734 and configured to receive the positioning assistance notification 1062 as described in connection with FIGS. 10A and 10B. In an example, the request for assistance may be a positioning request 1102 transmitted by the UE 731 as described in FIG. 11. The movable assistant transceiver may also receive assistance data including reference signal resource information (e.g., PRS resources, SL-PRS resources, etc.) from the RIS controller 722 or other network entity (e.g., UE, gNB, LMF) to configure PAS signals to be transmitted. In an example, the UE 731 may be configured to perform an assistance check based on the request for assistance to determine whether to transmit PAS.

At stage 1420, the method includes, responsive to the request for assistance, transmitting, from the movable assistant transceiver to the RIS, a plurality of sequential positioning assistance signals (PASs) for direction via the RIS. The UE 200, including processors 210 and the transceiver 215, is a means for transmitting the PAS to the RIS. In an example, the PAS may be configured as reference signals such as PRS, SRS, CSI-RS, SL-PRS or other reference signals which may be used in positioning or channel estimation procedures. The PAS may utilize different resource elements (REs) such that each of the sequential PAS may utilize a different center frequency, as depicted in FIG. 9. In an example, the bandwidth of the PAS may be based on a BWP or sub-band allocation established by a network entity (e.g., the LMF 120 in the communication system 100).

In addition, in certain implementations, the method 1400 may include certain features of the method 1500, as will be understood by those of ordinary skill in the art in view of this disclosure.

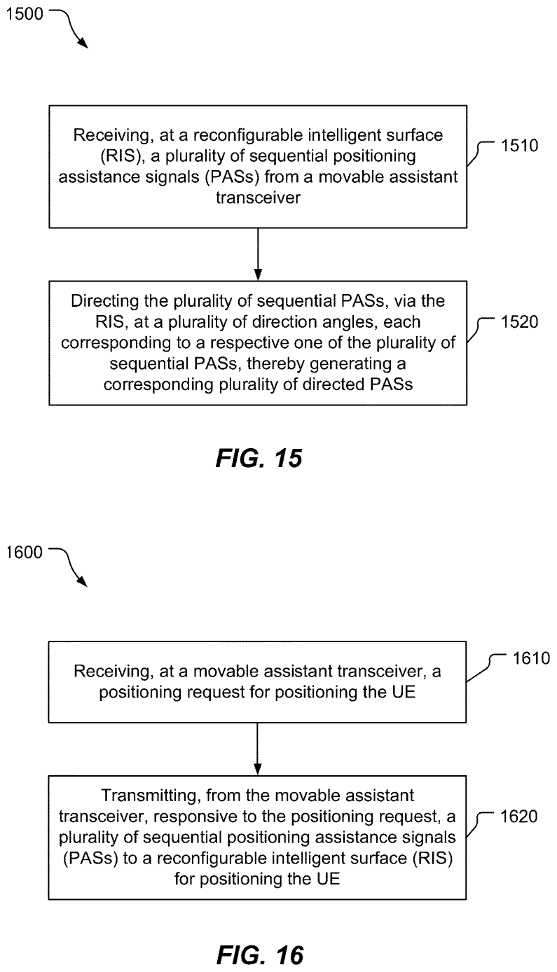

Referring to FIG. 15, with further reference to FIGS. 1-14, a method 1500 of positioning a user equipment (UE) is illustrated by a flow diagram and includes the stages shown. The method 1500 is, however, an example and not limiting. The method 1500 may be altered, e.g., by having stages added, removed, rearranged, combined, performed concurrently, and/or having single stages split into multiple stages.

At stage 1510, the method includes receiving, at a reconfigurable intelligent surface (RIS), a plurality of sequential positioning assistance signals (PASs) from a movable assistant transceiver. An RIS 720 and RIS controller 722 including a controller 590, are a means for receiving the plurality of PAS. In an example, the movable assistant transceiver may be the assistant UE 734 configured to repeatedly transmits PASs 748 to the RIS 720. The PAS may be configured as reference signals such as PRS, SRS, CSI-RS, SL-PRS or other reference signals which may be used in positioning or channel estimation procedures. In an example, the PAS may be configured as SL-PRS. The RIS 720 and the RIS controller 722 are configured to receive the sequential PAS. Other RIS configurations, such as a multi-panel RIS, or a sub-panel of an RIS may be configured to receive the PAS.

At stage 1520, the method includes directing the plurality of sequential PASs, via the RIS, at a plurality of direction angles, each corresponding to a respective one of the plurality of sequential PASs, thereby generating a corresponding plurality of directed PASs. The RIS 720 and RIS controller 722, including the controller 590, are a means for directing the plurality of sequential PAS (e.g., via reflection). The RIS controller 722 may include a RF switch matrix configured to and control the elements of the RIS 720 to enable the reflected PAS 771, 772, 772, 774 as described in FIG. 7. Other control circuits may be utilized to reflect the plurality of sequential PAS at the plurality of direction angles.

In addition, in certain implementations, the method 1500 may include certain features of the method 1300 or of the method 1400, as will be understood by those of ordinary skill in the art in view of this disclosure.

Referring to FIG. 16, with further reference to FIGS. 1-15, a method 1600 of positioning a user equipment (UE) is illustrated via a flow diagram and includes the stages shown. The method 1600 is, however, an example and not limiting. The method 1600 may be altered, e.g., by having stages added, removed, rearranged, combined, performed concurrently, and/or having single stages split into multiple stages.

At stage 1610, the method 1600 includes receiving, at a movable assistant transceiver, a positioning request for positioning the UE. A UE 200, including processors 210 and a transceiver 215, is a means for receiving a request for assistance. The movable assistant transceiver may be the assistant UE 734 and configured to receive the positioning assistance notification 1062 as described in FIGS. 10A and 10B. In an example, the request for assistance may be a positioning request 1102 transmitted by the UE 731 as described in FIG. 11. The movable assistant transceiver may also receive assistance data including reference signal resource information (e.g., PRS resources, SL-PRS resources, etc.) from the RIS controller 722 or other network entity (e.g., UE, gNB, LMF) to configure PAS signals to be transmitted. In an example, the UE 731 may be configured to perform an assistance check based on the request for assistance to determine whether to transmit PAS.

At stage 1620, the method includes transmitting, from the movable assistant transceiver, responsive to the positioning request, a plurality of sequential positioning assistance signals (PASs) to a reconfigurable intelligent surface (RIS) for positioning the UE. The UE 200, including processors 210 and the transceiver 215, is a means for transmitting the PAS to the RIS. In an example, the PAS may be configured as reference signals such as PRS, SRS, CSI-RS, SL-PRS or other reference signals which may be used in positioning or channel estimation procedures. The PAS may utilize different frequencies (e.g., sub-carriers), as depicted in FIG. 9.

In addition, in certain implementations, the method 1600 may include certain features of the method 1300, the method 1400, or the method 1500, as will be understood by those of ordinary skill in the art in view of this disclosure.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:
Clause 1. A method of providing positioning signals with a reconfigurable intelligent surface (RIS), comprising:
   selecting a movable assistant transceiver;
   receiving, at the RIS, a plurality of sequential positioning assistance signals (PASs) from the movable assistant transceiver; and
   directing the plurality of sequential PASs, via the RIS, at a plurality of direction angles, each corresponding to a respective one of the plurality of sequential PASs.
Clause 2. The method of clause 1 further comprising:
   providing a request for assistance to one or more candidate movable assistant transceivers;
   receiving indications to provide assistance from the one or more candidate movable assistant transceivers; and
   selecting the movable assistant transceiver based at least in part on the received indications to provide assistance.
Clause 3. The method of clause 2 further comprising determining location information for each of the one or more candidate movable assistant transceivers, and selecting the movable assistant transceiver is based at least in part on the location information.
Clause 4. The method of clause 3 wherein the location information for each of the one or more candidate movable assistant transceivers is received from a network server.
Clause 5. The method of clause 2 further comprising determining state information for each of the one or more candidate movable assistant transceivers, and wherein selecting the movable assistant transceiver is based at least in part on the state information.
Clause 6. The method of clause 5 wherein the state information includes a mobility state, a power state, a discontinuous reception pattern, or combinations thereof.
Clause 7. The method of clause 1 further comprising receiving a request for positioning from a user equipment.
Clause 8. The method of clause 1 further comprising transmitting an indication that the RIS is available for positioning.
Clause 9. The method of clause 1 wherein the PASs are sidelink positioning reference signals (SL-PRSs).
Clause 10. The method of clause 1 further comprising providing PAS timing and frequency information to the movable assistant transceiver.
Clause 11. A method of providing positioning signals with a reconfigurable intelligent surface (RIS), comprising:
   receiving, at a movable assistant transceiver, a request for assistance; and
   responsive to the request for assistance, transmitting, from the movable assistant transceiver to the RIS, a plurality of sequential positioning assistance signals (PASs) for directing by the RIS.
Clause 12. The method of clause 11, further comprising transmitting, from the movable assistant transceiver, responsive to the request for assistance, an indication to provide assistance.
Clause 13. The method of clause 11, further comprising transmitting, from the movable assistant transceiver to the RIS or to a user equipment (UE), location information for the movable assistant transceiver.
Clause 14. The method of clause 11, further comprising transmitting, from the movable assistant transceiver to the RIS or to a user equipment (UE), state information for the movable assistant transceiver.
Clause 15. The method of clause 14, wherein the state information includes a mobility state, a power state, or a discontinuous reception pattern of the movable assistant transceiver, or combinations thereof.
Clause 16. The method of clause 11, further comprising receiving, at the movable assistant transceiver, a request for positioning from a user equipment (UE).
Clause 17. The method of clause 11, wherein the plurality of sequential PASs are sidelink positioning reference signals (SL-PRSs).
Clause 18. The method of clause 11, further comprising receiving PAS timing and frequency information from the RIS.
Clause 19. A method of positioning a user equipment (UE), comprising:
   receiving, at a reconfigurable intelligent surface (RIS), a plurality of sequential positioning assistance signals (PASs) from a movable assistant transceiver; and
   directing the plurality of sequential PASs, via the RIS, at a plurality of direction angles, each corresponding to a respective one of the plurality of sequential PASs, thereby generating a corresponding plurality of directed PASs.
Clause 20. The method of clause 19, wherein the movable assistant transceiver is an assistant UE.
Clause 21. The method of clause 19, wherein the movable assistant transceiver is a Global Navigation Satellite System (GNSS).
Clause 22. The method of clause 19, further comprising receiving a positioning request from the UE.
Clause 23. The method of clause 22, further comprising relaying the positioning request to the movable assistant transceiver; receiving, from the movable assistant transceiver, an acceptance of the positioning request; and initiating the receiving the plurality of sequential PASs and the directing the plurality of sequential PASs responsive to the acceptance.
Clause 24. The method of clause 19, wherein the directing the plurality of sequential PASs includes directing at least a subset of the plurality of directed PASs toward the UE to be receivable by the UE.
Clause 25. A method of positioning a user equipment (UE), comprising:
   receiving, at a movable assistant transceiver, a positioning request for positioning the UE; and
   transmitting, from the movable assistant transceiver, responsive to the positioning request, a plurality of sequential positioning assistance signals (PASs) to a reconfigurable intelligent surface (RIS) for positioning the UE.
Clause 26. The method of clause 25, wherein the movable assistant transceiver is an assistant UE.
Clause 27. The method of clause 25, wherein the movable assistant transceiver is a Global Navigation Satellite System (GNSS).
Clause 28. The method of clause 25, further comprising receiving the positioning request from the UE and initiating the transmitting the plurality of sequential PASs responsive to the positioning request.
Clause 29. A system comprising:
   one or more transceivers;
   one or more memories; and
   one or more processors, communicatively coupled to the one or more transceivers and the one or more memories, the one or more processors configured to:
      select a movable assistant transceiver;
      receive, at a reconfigurable intelligent surface (RIS), a plurality of sequential positioning assistance signals (PASs) from the movable assistant transceiver; and
      direct the plurality of sequential PASs, via the RIS, at a plurality of direction angles, each corresponding to a respective one of the plurality of sequential PASs.
Clause 30. The system of clause 29, wherein the one or more processors are further configured to:
   provide a request for assistance to one or more candidate movable assistant transceivers;
   receive indications to provide assistance from the one or more candidate movable assistant transceivers; and
   select the movable assistant transceiver based at least in part on the received indications to provide assistance.
Clause 31. The system of clause 30, wherein the one or more processors are further configured to determine location information for each of the one or more candidate movable assistant transceivers and to select the movable assistant transceiver based at least in part on the location information.
Clause 32. The system of clause 31, wherein the location information for each of the one or more candidate movable assistant transceivers is received from a network server.
Clause 33. The system of clause 30, wherein the one or more processors are further configured to determine state information for each of the one or more candidate movable assistant transceivers and to select the movable assistant transceiver based at least in part on the state information.
Clause 34. The system of clause 33, wherein the state information includes a mobility state, a power state, a discontinuous reception pattern, or combinations thereof.
Clause 35. The system of clause 29, wherein the one or more processors are further configured to receive a request for positioning from a user equipment.
Clause 36. The system of clause 29, wherein the one or more processors are further configured to transmit an indication that the RIS is available for positioning.
Clause 37. The system of clause 29, wherein the PASs are sidelink positioning reference signals (SL-PRSs).
Clause 38. The system of clause 29, wherein the one or more processors are further configured to provide PAS timing and frequency information to the movable assistant transceiver.
Clause 39. A system comprising:
   a movable assistant transceiver;
   one or more memories; and
   one or more processors, communicatively coupled to the movable assistant transceiver and the one or more memories, the one or more processors configured to:
      receive, via the movable assistant transceiver, a request for assistance; and
      responsive to the request for assistance, transmit, from the movable assistant transceiver to a reconfigurable intelligent surface (RIS), a plurality of sequential positioning assistance signals (PASs) for directing by the RIS.
Clause 40. The system of clause 39, wherein the one or more processors are further configured to transmit, from the movable assistant transceiver, responsive to the request for assistance, an indication to provide assistance.
Clause 41. The system of clause 39, wherein the one or more processors are further configured to transmit, from the movable assistant transceiver to the RIS or to a user equipment (UE), location information for the movable assistant transceiver.
Clause 42. The system of clause 39, wherein the one or more processors are further configured to transmit, from the movable assistant transceiver to the RIS or to a user equipment (UE), state information for the movable assistant transceiver.
Clause 43. The system of clause 42, wherein the state information includes a mobility state, a power state, or a discontinuous reception pattern of the movable assistant transceiver, or combinations thereof.
Clause 44. The system of clause 39, wherein the one or more processors are further configured to receive, via the movable assistant transceiver, a request for positioning from a user equipment (UE).
Clause 45. The system of clause 39, wherein the plurality of sequential PASs are sidelink positioning reference signals (SL-PRSs).
Clause 46. The system of clause 39, wherein the one or more processors are further configured to receive PAS timing and frequency information from the RIS.
Clause 47. A system comprising:
   one or more transceivers;
   one or more memories; and
   one or more processors, communicatively coupled to the one or more transceivers and the one or more memories, the one or more processors configured to:
      receive, via a reconfigurable intelligent surface (RIS), a plurality of sequential positioning assistance signals (PASs) from a movable assistant transceiver; and
      direct the plurality of sequential PASs, via the RIS, at a plurality of direction angles, each corresponding to a respective one of the plurality of sequential PASs, thereby generating a corresponding plurality of directed PASs.
Clause 48. The system of clause 47, wherein the movable assistant transceiver comprises an assistant UE.
Clause 49. The system of clause 47, wherein the movable assistant transceiver comprises a Global Navigation Satellite Systems (GNSS).
Clause 50. The system of clause 47, wherein the one or more processors are further configured to receive a positioning request from a UE.
Clause 51. The system of clause 50, wherein the one or more processors are further configured to:
   relay the positioning request to the movable assistant transceiver;
   receive, from the movable assistant transceiver, an acceptance of the positioning request; and
   initiate the receive the plurality of sequential PASs and the direct the plurality of sequential PASs responsive to the acceptance.
Clause 52. The system of clause 47, wherein the one or more processors are further configured to direct at least a subset of the plurality of directed PASs toward a UE to be receivable by the UE.
Clause 53. A system comprising:
   a movable assistant transceiver;
   one or more memories; and
   one or more processors, communicatively coupled to the movable assistant transceiver and the one or more memories, the one or more processors configured to:
      receive, via the movable assistant transceiver, a positioning request for positioning a UE; and
      transmit, via the movable assistant transceiver, responsive to the positioning request, a plurality of sequential positioning assistance signals (PASs) to a reconfigurable intelligent surface (RIS) for positioning the UE.
Clause 54. The system of clause 53, wherein the movable assistant transceiver comprises a movable assistant UE.
Clause 55. The system of clause 53, wherein the movable assistant transceiver comprises a Global Navigation Satellite System (GNSS).
Clause 56. The system of clause 53, wherein the one or more processors are further configured to receive the positioning request from the UE and to initiate the transmit the plurality of sequential PASs responsive to the positioning request.
Clause 57. A system comprising:
   means for selecting a movable assistant transceiver;
   means for receiving, at a reconfigurable intelligent surface (RIS), a plurality of sequential positioning assistance signals (PASs) from the movable assistant transceiver; and
   means for directing the plurality of sequential PASs, via the RIS, at a plurality of direction angles, each corresponding to a respective one of the plurality of sequential PASs.
Clause 58. A system comprising:
   means for receiving, at a movable assistant transceiver, a request for assistance; and
   means for transmitting, responsive to the request for assistance, from the movable assistant transceiver to a reconfigurable intelligent surface (RIS), a plurality of sequential positioning assistance signals (PASs) for directing by the RIS.
Clause 59. A system comprising:
   means for receiving, at a reconfigurable intelligent surface (RIS), a plurality of sequential positioning assistance signals (PASs) from a movable assistant transceiver; and
   means for directing the plurality of sequential PASs, via the RIS, at a plurality of direction angles, each corresponding to a respective one of the plurality of sequential PASs, thereby generating a corresponding plurality of directed PASs.
Clause 60. A system comprising:
   means for receiving, at a movable assistant transceiver, a positioning request for positioning a user equipment (UE); and
   means for transmitting, from the movable assistant transceiver, responsive to the positioning request, a plurality of sequential positioning assistance signals (PASs) to a reconfigurable intelligent surface (RIS) for positioning the UE.
Clause 61. A non-transitory, processor-readable storage medium comprising processor-readable instructions to cause one or more processors, of a system including a reconfigurable intelligent surface (RIS), to:
   select a movable assistant transceiver;
   receive, at the RIS, a plurality of sequential positioning assistance signals (PASs) from the movable assistant transceiver; and
   direct the plurality of sequential PASs, via the RIS, at a plurality of direction angles, each corresponding to a respective one of the plurality of sequential PASs.
Clause 62. A non-transitory, processor-readable storage medium comprising processor-readable instructions to cause one or more processors, of a movable assistant transceiver, to:
   receive, at a movable assistant transceiver, a request for assistance; and
   transmit, responsive to the request for assistance, from the movable assistant transceiver to a reconfigurable intelligent surface (RIS), a plurality of sequential positioning assistance signals (PASs) for directing by the RIS.
Clause 63. A non-transitory, processor-readable storage medium comprising processor-readable instructions to cause one or more processors, of system including a reconfigurable intelligent surface (RIS), to:
   receive, at the RIS, a plurality of sequential positioning assistance signals (PASs) from a movable assistant transceiver; and
   direct the plurality of sequential PASs, via the RIS, at a plurality of direction angles, each corresponding to a respective one of the plurality of sequential PASs, thereby generating a corresponding plurality of directed PASs.
Clause 64. A non-transitory, processor-readable storage medium comprising processor-readable instructions to cause one or more processors, of a movable assistant transceiver, to:
   receive, at the movable assistant transceiver, a positioning request for positioning a user equipment (UE); and
   transmit, from the movable assistant transceiver, responsive to the positioning request, a plurality of sequential positioning assistance signals (PASs) to a reconfigurable intelligent surface (RIS) for positioning the UE.

1. A method of providing positioning signals with a reconfigurable intelligent surface (RIS), comprising:
selecting a movable assistant transceiver;
receiving, at the RIS, a plurality of sequential positioning assistance signals (PASs) from the movable assistant transceiver; and
directing the plurality of sequential PASs, via the RIS, at a plurality of direction angles, each corresponding to a respective one of the plurality of sequential PASs.

2. The method of claim 1 further comprising:
providing a request for assistance to one or more candidate movable assistant transceivers;
receiving indications to provide assistance from the one or more candidate movable assistant transceivers; and
selecting the movable assistant transceiver based at least in part on the received indications to provide assistance.

3. The method of claim 2 further comprising determining location information for each of the one or more candidate movable assistant transceivers, and selecting the movable assistant transceiver is based at least in part on the location information.

4. The method of claim 3 wherein the location information for each of the one or more candidate movable assistant transceivers is received from a network server.

5. The method of claim 2 further comprising determining state information for each of the one or more candidate movable assistant transceivers, and wherein selecting the movable assistant transceiver is based at least in part on the state information.

6. The method of claim 5 wherein the state information includes a mobility state, a power state, a discontinuous reception pattern, or combinations thereof.

7. The method of claim 1 further comprising receiving a request for positioning from a user equipment.

8. The method of claim 1 further comprising transmitting an indication that the RIS is available for positioning.

9. The method of claim 1 wherein the PASs are sidelink positioning reference signals (SL-PRSs).

10. The method of claim 1 further comprising providing PAS timing and frequency information to the movable assistant transceiver.

11. A method of positioning a user equipment (UE), comprising:
receiving, at a reconfigurable intelligent surface (RIS), a plurality of sequential positioning assistance signals (PASs) from a movable assistant transceiver; and
directing the plurality of sequential PASs, via the RIS, at a plurality of direction angles, each corresponding to a respective one of the plurality of sequential PASs, thereby generating a corresponding plurality of directed PASs.

12. The method of claim 11, wherein the movable assistant transceiver is an assistant UE.

13. The method of claim 11, wherein the movable assistant transceiver is a Global Navigation Satellite System (GNSS).

14. The method of claim 11, further comprising receiving a positioning request from the UE.

15. The method of claim 14, further comprising relaying the positioning request to the movable assistant transceiver; receiving, from the movable assistant transceiver, an acceptance of the positioning request; and initiating the receiving the plurality of sequential PASs and the directing the plurality of sequential PASs responsive to the acceptance.

16. The method of claim 11, wherein the directing the plurality of sequential PASs includes directing at least a subset of the plurality of directed PASs toward the UE to be receivable by the UE.

17. A system comprising:
one or more transceivers;
one or more memories; and
one or more processors, communicatively coupled to the one or more transceivers and the one or more memories, the one or more processors configured to:
select a movable assistant transceiver;
receive, at a reconfigurable intelligent surface (RIS), a plurality of sequential positioning assistance signals (PASs) from the movable assistant transceiver; and
direct the plurality of sequential PASs, via the RIS, at a plurality of direction angles, each corresponding to a respective one of the plurality of sequential PASs.

18. The system of claim 17, wherein the one or more processors are further configured to:
provide a request for assistance to one or more candidate movable assistant transceivers;
receive indications to provide assistance from the one or more candidate movable assistant transceivers; and
select the movable assistant transceiver based at least in part on the received indications to provide assistance.

19. The system of claim 18, wherein the one or more processors are further configured to determine location information for each of the one or more candidate movable assistant transceivers and to select the movable assistant transceiver based at least in part on the location information.

20. The system of claim 19, wherein the location information for each of the one or more candidate movable assistant transceivers is received from a network server.

21-30. (canceled)
